(19) United States
(12) Patent Application Publication
(10) Pub. No.: US 2026/0012039 A1
(43) Pub. Date: Jan. 8, 2026

(54) COIL UNIT AND COIL UNIT INSTALLATION STRUCTURE

(71) Applicant: HONDA MOTOR CO., LTD., Tokyo (JP)

(72) Inventor: Jin Katsuya, Wako-shi (JP)

(21) Appl. No.: 19/241,472

(22) Filed: Jun. 18, 2025

(30) Foreign Application Priority Data
Jul. 2, 2024 (JP) 2024-106958

(51) Int. Cl. H02J 50/00; H01F 27/00; H01F 27/02; H01F 38/14

(52) U.S. Cl. CPC H02J 50/005; H01F 27/004; H01F 27/02; H01F 38/14

(57) ABSTRACT

A coil unit includes a coil structure body, a lid portion, an accommodation portion, and an electric device. The coil structure body includes a coil and a coil support portion that supports the coil. The accommodation portion is arranged in a penetration hole formed on the coil support portion. The accommodation portion accommodates the electric device at an inside of the accommodation portion. The lid portion closes and opens an open end of the penetration hole of the coil support portion. The lid portion is supported by the accommodation portion when the penetration hole is closed.

### CROSS-REFERENCE TO RELATED APPLICATION

Priority is claimed on Japanese Patent Application No. 2024-106958, filed on Jul. 2, 2024, the contents of which are incorporated herein by reference.

### BACKGROUND

### Field of the Invention

The present invention relates to a coil unit and a coil unit installation structure.

### Background

In recent years, in order to ensure that more people have access to affordable, reliable, sustainable, and advanced energy, research and development relating to charging and electric power supply in a vehicle in which a secondary battery is mounted, which contributes to energy efficiency, has been conducted.

In the related art, in a contactless electric power transmission system that supplies electric power to a vehicle from the outside of the vehicle by contactless electric power transmission, a pavement structure is known which includes: a case that accommodates an electric power transmission coil and is embedded in a road; and a lid member that closes an upper opening of the case, wherein an upper surface of the lid member forms part of a pavement surface (for example, refer to Japanese Unexamined Patent Application, First Publication No. 2023-023997).

### SUMMARY

In techniques relating to charging and electric power supply in a vehicle on which a secondary battery is mounted, it is desired to improve maintenance easiness and robustness of a coil unit in the contactless electric power transmission. For example, when the lid member of the case that accommodates the entire electric power transmission side coil is provided as in the pavement structure of the related art described above, there is a possibility that the size and the weight of the entire structure body are increased and that desired robustness cannot be ensured against a load that acts on the lid member. For example, in the case where a coil structure body in which a road surface of a precast structure manufactured in advance in a factory or the like and an electric power transmission coil are integrated is embedded in a road, a problem arises in that the work and cost required for construction are increased in accordance with an increase of the size and the weight of the coil structure body or the like. Further, as in the pavement structure of the related art described above, there is a possibility that the desired robustness cannot be ensured against a load due to a vehicle body weight, load movement, and the like only by providing a support member having a column shape and made of a non-magnetic resin material which is inserted from a bottom wall portion of the case into an air core region of the electric power transmission coil and supports a middle portion of the lid member.

An aspect of the present invention aims at providing a coil unit and a coil unit installation structure which can improve maintenance easiness and robustness. Further, the aspect of the present invention contributes to energy efficiency.

A coil unit according to a first aspect of the present invention includes: a coil that transmits or receives electric power by contactless electric power transmission; a coil support portion that supports the coil and has a penetration hole formed along a center axis line of the coil; an accommodation portion that is arranged in the penetration hole of the coil support portion; an electric device that is arranged inside the accommodation portion; and a lid portion that closes and opens an open end of the penetration hole of the coil support portion and is supported by the accommodation portion when the penetration hole is closed.

A second aspect is the coil unit according to the first aspect described above, wherein the lid portion may protrude further than the coil toward a partner side in a case where an electric power transmission side and an electric power reception side of the electric power transmission face each other in an axis line direction parallel to the center axis line.

A third aspect is the coil unit according to the second aspect described above which may include: an accommodation lid portion that closes and opens an opening formed in a region on a lid portion side of an outer circumferential section of the accommodation portion.

A fourth aspect is the coil unit according to any one of the first to third aspects described above which may include: a first yoke portion that is made of a magnetic material and is arranged on a rear side of the coil when seen from a lid portion side in an axis line direction parallel to the center axis line; and a second yoke portion (for example, a second yoke portion 15 and a third yoke portion 16 in an embodiment) that is made of a magnetic material and is arranged so as to surround each of the lid portion side and a coil support portion side of a circumference of the accommodation portion in the penetration hole.

A coil unit installation structure according to a fifth aspect of the present invention includes: a coil unit according to any one of the first to third aspects described above that is embedded in a travel path in a state where a surface of the lid portion is exposed to an outside; and a base portion that supports the coil unit at an inside of the travel path.

A sixth aspect is the coil unit installation structure according to the fifth aspect described above which may include: a support portion that is installed at the inside of the travel path, wherein the base portion may be fixed to the support portion by bonding or fastening.

A seventh aspect is the coil unit installation structure according to the fifth aspect described above which may include: a plate-shaped member that is arranged between the base portion and the inside of the travel path.

According to the first aspect described above, since the lid portion that closes the penetration hole of the coil support portion is supported by the accommodation portion arranged in the penetration hole, it is possible to ensure maintenance easiness of repair, replacement, and the like of the electric device accommodated in the accommodation portion and to improve robustness of the lid portion. For example, as compared with the case where a coil structure body in which a road surface of a precast structure and an electric power transmission coil are integrated is embedded in a travel path or the like, it is possible to improve construction easiness and to shorten the time required for construction while ensuring desired robustness.

In the case of the second aspect described above, since the lid portion protrudes further than the coil toward a partner side of the electric power transmission, it is possible to prevent a load that acts on the lid portion from the outside from directly acting on the coil.

In the case of the third aspect described above, the electric device in the accommodation space can be protected by the accommodation lid portion that closes the opening of the accommodation portion, the electric device can be easily exposed to the outside by the lid portion and the accommodation lid portion, and the maintenance easiness of the electric device can be improved.

In the case of the fourth aspect described above, by including the first yoke portion and the second yoke portion, it is possible to improve a coupling coefficient.

According to the fifth aspect described above, since the load that acts on the lid portion from the outside escapes directly to the inside of the travel path, that is, for example, to a road bed or the like via the accommodation portion and the base portion, it is possible to prevent an excessive load from acting on the electric device and the coil.

In the case of the sixth aspect described above, since the base portion is fixed to the support portion at the inside of the travel path by bonding or fastening, it is possible to improve construction easiness and to shorten the time required for construction.

In the case of the seventh aspect described above, by including the plate-shaped member, it is possible to stabilize the support of the coil unit with respect to the inside of the travel path such as a road bed.

### BRIEF DESCRIPTION OF THE DRAWINGS

FIG. 1 is a perspective view of a coil unit of an embodiment of the present invention.

FIG. 2 is a cross-sectional view in which the coil unit of the embodiment of the present invention is cut by a plane parallel to each of a Y-Z plane and a Z-X plane at a position of an A-B-C line shown in FIG. 1.

FIG. 3 is a cross-sectional view in which a coil unit and an example of an installation structure of the embodiment of the present invention is cut by the Z-X plane (a plane orthogonal to a Y axis) at a position of a D-D line shown in FIG. 1.

FIG. 4 is a cross-sectional view in which the coil unit and another example of the installation structure of the embodiment of the present invention is cut by the Z-X plane (the plane orthogonal to the Y axis) at the position of the D-D line shown in FIG. 1.

FIG. 5 is a plan view of the coil unit of the embodiment of the present invention when seen from a Z-axis direction while omitting a lid portion.

FIG. 6 is a cross-sectional view in which the coil unit of the embodiment of the present invention and an installation structure of a first modification example are cut by the Z-X plane (the plane orthogonal to the Y axis) at the position of the D-D line shown in FIG. 1.

FIG. 7 is a cross-sectional view in which the coil unit of the embodiment of the present invention and an installation structure of a second modification example are cut by the Z-X plane (the plane orthogonal to the Y axis) at the position of the D-D line shown in FIG. 1.

### DESCRIPTION OF EMBODIMENTS

Hereinafter, a coil unit and a coil unit installation structure according to an embodiment of the present invention will be described below with reference to the accompanying drawings.

A coil unit 10 of the embodiment constitutes, for example, at least one of an electric power transmission device and an electric power reception device of a contactless electric power transmission system that supplies electric power from the outside of a movable body such as a vehicle to the movable body by contactless electric power transmission. The coil unit 10 of the embodiment is provided, for example, on the electric power transmission device installed on a travel path of the movable body or the like.

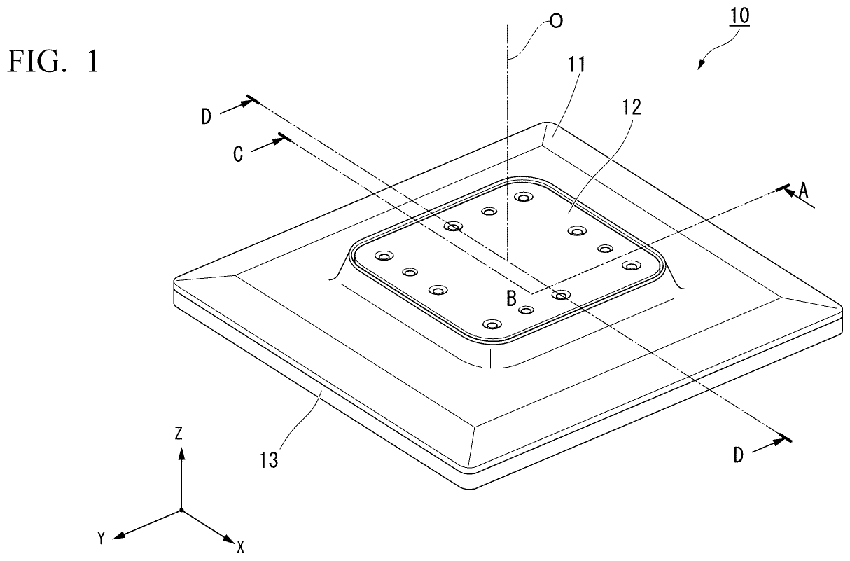

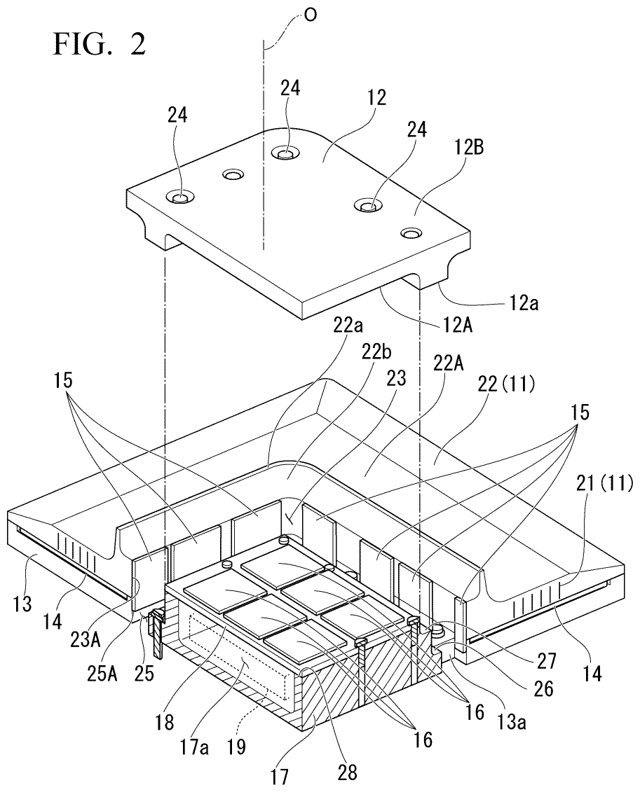

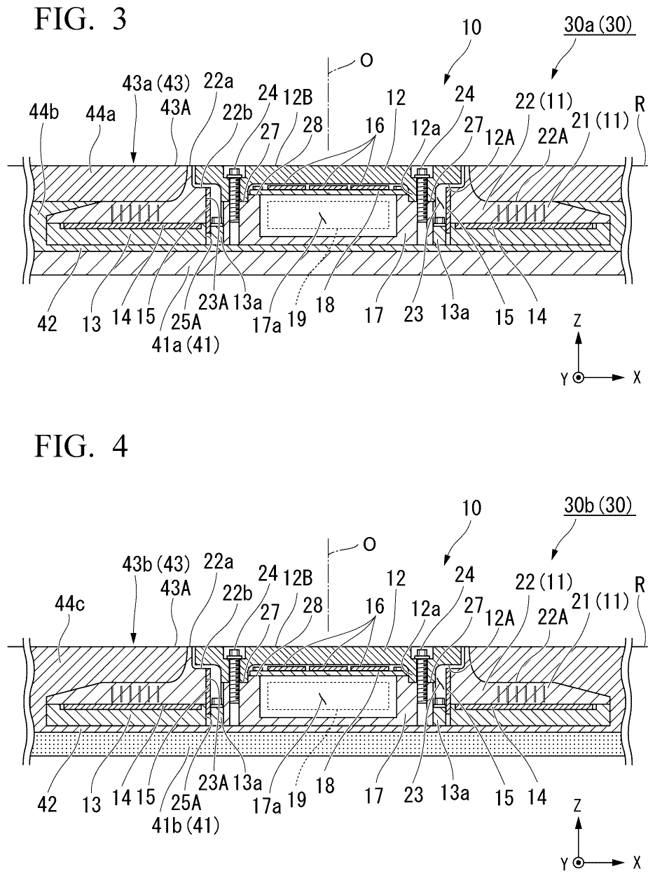

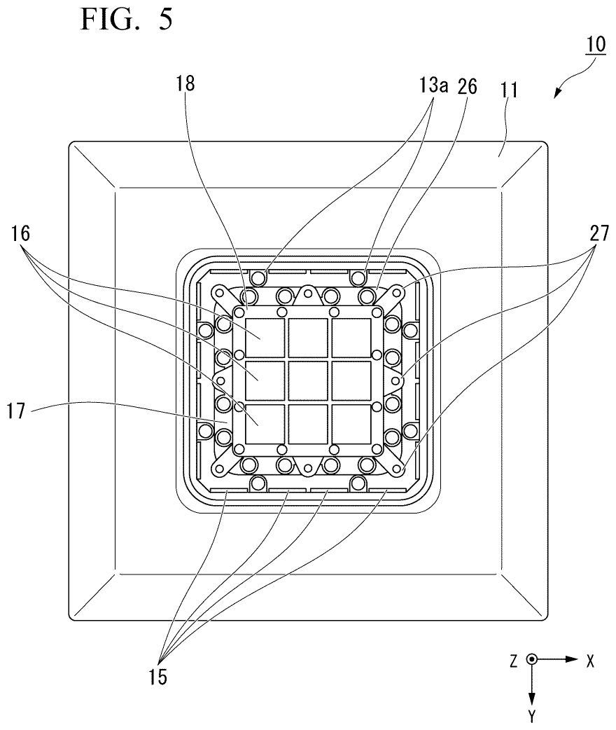

FIG. 1 is a perspective view of the coil unit 10 of the embodiment. FIG. 2 is a cross-sectional view in which the coil unit 10 of the embodiment is cut by a plane parallel to each of a Y-Z plane and a Z-X plane at a position of an A-B-C line shown in FIG. 1. FIG. 3 is a cross-sectional view in which the coil unit 10 and an example (30a) of an installation structure 30 of the embodiment is cut by the Z-X plane (a plane orthogonal to a Y axis) at a position of a D-D line shown in FIG. 1. FIG. 4 is a cross-sectional view in which the coil unit 10 and another example (30b) of the installation structure 30 of the embodiment is cut by the Z-X plane (the plane orthogonal to the Y axis) at the position of the D-D line shown in FIG. 1.

In the following description, each axis direction of an X-axis, a Y-axis, and a Z-axis orthogonal to each other in a three-dimensional space is a direction parallel to each axis of the coil unit 10. For example, as shown in FIG. 1, the X-axis direction and the Y-axis direction are parallel to a forward-rearward direction and a rightward-leftward direction of the coil unit 10, and the Z-axis direction is parallel to an upward-downward direction (thickness direction) of the coil unit 10. For example, the positive direction in the Z-axis direction is the direction toward a partner side in the case where a coil on an electric power transmission side and a coil on an electric power reception side of the contactless electric power transmission system face each other.

As shown in FIG. 1 to FIG. 4, the coil unit 10 of the embodiment includes, for example, a coil structure body 11, a lid portion 12, a coil base portion 13, a plurality of first yoke portions 14, a plurality of second yoke portions 15, a plurality of third yoke portions 16, an accommodation portion 17, an accommodation lid portion 18, and an electric device 19.

The coil structure body 11 includes, for example, a coil 21 and a coil support portion 22 that supports the coil 21.

An outer shape of the coil 21 is, for example, a shape in which an electric wire such as a rectangular copper wire is wound around a center axis line O in a spiral form having a round-cornered rectangular shape.

An outer shape of the coil support portion 22 is, for example, a round-cornered rectangular annular plate shape which covers the entire coil 21 and in which a penetration hole 23 is coaxially formed along the center axis line O of the coil 21. The coil support portion 22 is formed, for example, by casting using a thermally conductive resin such as polycarbonate and urethane.

The coil support portion 22 includes, for example, a wall section 22a that protrudes upward from an upper surface 22A on an inner circumferential portion between an inner circumferential wall 23A that forms the penetration hole 23 and an inner circumference of the coil 21. An outer shape of the wall section 22a is, for example, a round-cornered rectangular cylindrical shape. The wall section 22a and an inner circumferential section 22b on a further inner circumferential side than the wall section 22a form, for example, a space in which an outer circumferential section of the lid portion 12 described later is arranged at a higher position than the coil 21 in an axis line direction parallel to the center axis line O. A front end (upper end) of the wall section 22a is set so as not to protrude further upward than at least an upper end of the lid portion 12.

An outer shape of the lid portion 12 is, for example, a round-cornered rectangular plate shape. The lid portion 12 is formed of, for example, a resin material such as fiber reinforced plastic (FRP) and a metal material such as aluminum. The lid portion 12 closes and opens an open end on an upper side of the penetration hole 23 of the coil support portion 22.

The lid portion 12 includes, for example, a leg section 12a that protrudes downward from a lower surface 12A on an outer circumferential section shifted inward from an outer circumferential surface. An outer shape of the leg section 12a is, for example, a round-cornered rectangular cylindrical shape. The leg section 12a is supported, for example, by coming into contact with the accommodation portion 17 described later when the penetration hole 23 is closed. The lid portion 12 is fastened and fixed to the accommodation portion 17, for example, by a plurality of bolts 24 which are attached to a plurality of bolt holes that penetrate in the thickness direction through a region where the leg 12a is provided.

An outer shape of the coil base portion 13 is, for example, a round-cornered rectangular annular plate shape in which a penetration hole 25 that communicates with the penetration hole 23 of the coil support portion 22 is coaxially formed. For example, the size of an outer circumference of the coil base portion 13 and the penetration hole 25 are the same as the size of an outer circumference of the coil support portion 22 and the penetration hole 23. The coil base portion 13 is formed of, for example, a thermally conductive resin such as polycarbonate.

The coil base portion 13 is integrally in contact with a lower section of the coil support portion 22 and supports the coil support portion 22. The coil base portion 13 holds, for example, a plurality of first yoke portions 14 described later that is arranged between the coil base portion 13 and the coil support portion 22. The inner circumferential wall 25A, 23A that forms the penetration hole 25, 23 of each of the coil base portion 13 and the coil support portion 22 holds, for example, a plurality of second yoke portions 15 described later that are fixed by adhesion or the like.

The coil base portion 13 includes, for example, a plurality of base portions 13a that protrude inward from the inner circumferential wall 25A that forms the penetration hole 25. The coil base portion 13 is fastened and fixed to a base portion 42 described later, for example, by a bolt which is attached to a bolt hole that penetrates in the thickness direction through each base portion 13a.

An outer shape of each of the plurality of first yoke portions 14, the plurality of second yoke portions 15, and the plurality of third yoke portions 16 is, for example, a rectangular plate shape. Each yoke portion 14, 15, 16 is formed of, for example, a magnetic material such as ferrite, a nanocrystalline soft magnetic sheet, and an electromagnetic steel sheet.

The plurality of first yoke portions 14 are arranged, for example, between the coil base portion 13 and the coil support portion 22 so that a center axis of each first yoke portion 14 is parallel to the center axis line O. The plurality of first yoke portions 14 are arranged on a rear side of the coil 21 when seen from the lid portion 12 side in an axis line direction parallel to the center axis line O.

The plurality of second yoke portions 15 are arranged, for example, on the inner circumferential wall 25A, 23A that forms the penetration hole 25, 23 of each of the coil base portion 13 and the coil support portion 22 so that a center axis of each second yoke portion 15 is parallel to a direction orthogonal to the center axis line O.

The plurality of third yoke portions 16 are arranged, for example, on an upper surface of the accommodation lid portion 18 described later so that a center axis of each third yoke portion 16 is parallel to the center axis line O.

For example, the plurality of first yoke portions 14 provided as a back yoke of the coil 21, and the plurality of second yoke portions 15 and the plurality of third yoke portions 16 that surround a circumference of the accommodation portion 17 described later in an air core region of the coil 21 form a magnetic circuit having a flanged box shape.

An outer shape of the accommodation portion 17 is, for example, a box shape in which an opening is formed on an upper section. The accommodation portion 17 is formed of, for example, an aluminum alloy or the like. An electric power converter such as an inverter formed of a plurality of switching elements and rectifier elements, a resistor and a capacitor (condenser) that are connected to the coil 21 and form a resonance circuit, and the electric device 19 such as various boards are arranged in an accommodation space 17a formed at the inside of the accommodation portion 17.

The accommodation portion 17 includes, for example, a first flange portion 26 and a plurality of second flange portions 27 that protrude outward from an outer circumferential surface. The first flange portion 26 is provided, for example, continuously over the entire circumference of the outer circumferential surface of the accommodation portion 17. The plurality of second flange portions 27 are provided, for example, so as to protrude radially from a plurality of predetermined positions of the outer circumferential surface of the accommodation portion 17. The plurality of predetermined positions of the outer circumferential surface of the accommodation portion 17 are, for example, four corner portions and a middle portion between two adjacent corner portions.

The accommodation portion 17 is fastened and fixed to the base portion 42 described later, for example, by a plurality of bolts which are attached to a plurality of bolt holes that penetrate in the thickness direction (a direction parallel to the center axis line O) through the first flange portion 26.

Each of the plurality of second flange portions 27 supports the leg section 12a of the lid portion 12 that closes the penetration hole 23 of the coil support portion 22. The accommodation portion 17 fastens and fixes the lid portion 12 by each bolt 24 that is attached to each bolt hole of the lid portion 12 and the bolt hole provided along the thickness direction of each second flange portion 27.

The accommodation lid portion 18 is formed of, for example, an aluminum alloy such as aluminum to which magnesium is added. The accommodation lid portion 18 closes and opens an opening formed on an upper section of the accommodation portion 17. The accommodation lid portion 18 is fastened and fixed to an upper circumferential edge portion 28 (a region on a lid portion side of an outer circumferential section of the accommodation portion) that surrounds an open end of the accommodation portion 17, for example, by a plurality of bolts which are attached to a plurality of bolt holes that penetrate in the thickness direction through the accommodation lid portion 18.

As shown in FIG. 3 and FIG. 4, the coil unit 10 of the embodiment is embedded in a travel path R as the installation structure 30 in a state where an upper surface 12B of the lid portion 12 is exposed to the outside. For example, the upper surface 12B of the lid portion 12 and a road surface of the travel path R form an identical surface.

The installation structure 30a (30) of the coil unit 10 shown in FIG. 3 corresponds, for example, to the case where the travel path R is a high-standard road such as an express highway and a motorway. The installation structure 30a includes, for example, a support portion 41a (41), a base portion 42, and a backfilling portion 43a (43).

The support portion 41a (41) is, for example, a plate-shaped member that is installed on a road bed inside an excavated travel path R. The support portion 41a is formed of, for example, plain concrete or the like.

The base portion 42 is, for example, a plate-shaped member arranged between the support portion 41a and the coil unit 10. The base portion 42 is formed of, for example, resin mortar or the like. The base portion 42 is bonded and fixed to the support portion 41a, for example, by a resin adhesive.

The backfilling portion 43a (43) is formed, for example, by excavation of the travel path R and is formed by backfilling and filling of an internal space where the coil unit 10 is arranged.

For example, an upper surface 43A of the backfilling portion 43a and the upper surface 12B of the lid portion 12 form an identical surface. The backfilling portion 43a includes, for example, an outer layer section 44a that is exposed to the outside and an inner layer section 44b.

The outer layer section 44a is provided, for example, in a space to the upper surface 22A of the coil support portion 22 toward the internal space. The outer layer section 44a is formed of, for example, dense graded asphalt or the like.

The inner layer section 44b is provided, for example, between the outer layer section 44a and the support portion 41a. The inner layer section 44b is formed of, for example, resin mortar or the like.

The installation structure 30b (30) of the coil unit 10 shown in FIG. 4 corresponds, for example, to the case where the travel road R is a road other than the high-standard road such as a so-called general road. The installation structure 30b includes, for example, a support portion 41b (41), a base portion 42, and a backfilling portion 43b (43).

The support portion 41b (41) is, for example, a predetermined layer that is installed on the road bed inside the excavated travel path R. The support portion 41b is formed of, for example, a mechanically stabilized crushed stone or the like.

The base portion 42 is, for example, a plate-shaped member arranged between the support portion 41b and the coil unit 10. The base portion 42 is formed of, for example, resin mortar or the like.

The backfilling portion 43b (43) is formed, for example, by excavation of the travel path R and is formed by backfilling and filling of an internal space where the coil unit 10 is arranged.

For example, an upper surface 43A of the backfilling portion 43b and the upper surface 12B of the lid portion 12 form an identical surface. The backfilling portion 43a includes, for example, an outer layer section 44c that is exposed to the outside.

The outer layer section 44c is provided, for example, in a space to the support portion 41b toward the internal space. The outer layer section 44c is formed of, for example, resin mortar or the like.

As described above, according to the coil unit 10 of the embodiment, since the lid portion 12 that closes the penetration hole 23 of the coil support portion 22 is supported by the accommodation portion 17 arranged in the penetration hole 23, it is possible to ensure maintenance easiness of repair, replacement, and the like of the electric device 19 accommodated in the accommodation portion 17 and to improve robustness of the lid portion 12. For example, as compared with the case where a coil structure body in which a road surface of a precast structure and an electric power transmission coil are integrated is embedded in a travel path or the like, it is possible to improve construction easiness and to shorten the time required for construction while ensuring desired robustness.

Since the lid portion 12 protrudes further than the coil 21 toward a partner side (electric power reception side) of the electric power transmission, it is possible to prevent a load that acts on the lid portion 12 from the outside from directly acting on the coil 21. The electric device 19 in the accommodation space 17a can be protected by the accommodation lid portion 18 that closes the opening of the accommodation portion 17, the electric device 19 can be easily exposed to the outside by the lid portion 12 and the accommodation lid portion 18, and the maintenance easiness of the electric device 19 can be improved.

By including the first yoke portion 14, the second yoke portion 15, and the third yoke portion 16 that form the magnetic circuit, it is possible to improve the coupling coefficient.

According to the installation structure 30 of the embodiment, since the load that acts on the lid portion 12 from the outside escapes directly to the inside of the travel path R, that is, for example, to a road bed or the like via the accommodation portion 17 and the base portion 42, it is possible to prevent an excessive load from acting on the electric device 19 and the coil 21.

### Modification Example

Hereinafter, modification examples of the embodiment are described. The same parts as those of the embodiment described above are denoted by the same reference numerals, and descriptions thereof are omitted or simplified.

In the installation structure 30a of the embodiment described above, the base portion 42 is bonded and fixed to the support portion 41a, for example, by a resin adhesive, but the embodiment is not limited thereto.

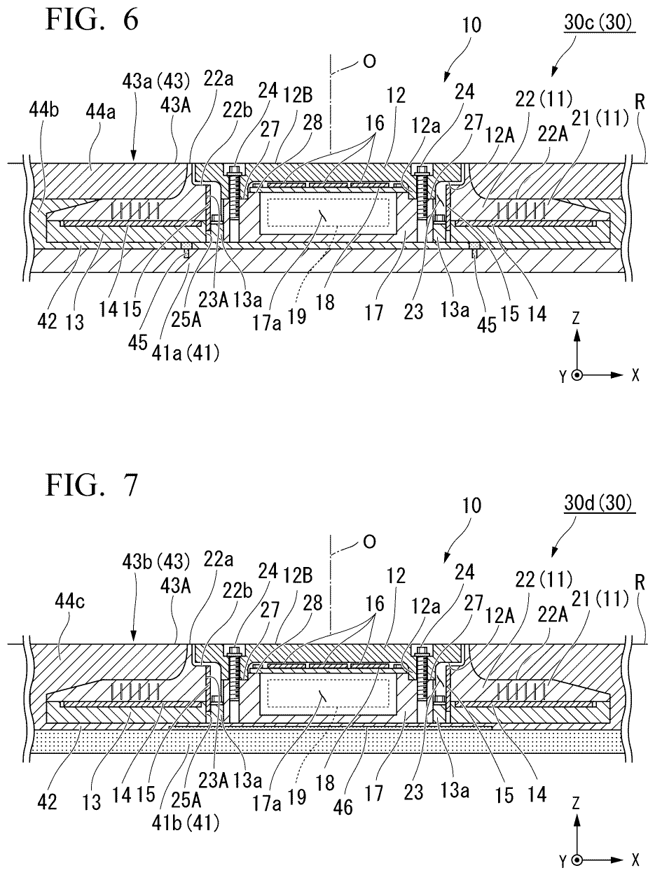

FIG. 6 is a cross-sectional view in which the coil unit 10 of the embodiment and an installation structure 30c (30) of a first modification example are cut by the Z-X plane (the plane orthogonal to the Y axis) at the position of the D-D line shown in FIG. 1. As shown in FIG. 6, the installation structure 30c of the first modification example may include a bolt 45 that fastens and fixes the base portion 42 to the support portion 41a.

According to the first modification example, since the base portion 42 is fixed to the support portion 41a at the inside of the travel path R by bonding or fastening, it is possible to improve construction easiness and to shorten the time required for construction.

In the installation structure 30b of the embodiment described above, the base portion 42 is arranged between the support portion 41b and the coil unit 10, but the embodiment is not limited thereto.

FIG. 7 is a cross-sectional view in which the coil unit 10 of the embodiment and an installation structure 30d (30) of a second modification example are cut by the Z-X plane (the plane orthogonal to the Y axis) at the position of the D-D line shown in FIG. 1.

As shown in FIG. 7, the installation structure 30d of the second modification example may include a plate-shaped member 46 that is arranged between the base portion 42 and the support portion 41b. The plate-shaped member 46 may be formed of, for example, a metal material such as aluminum.

According to the second modification example, by including the plate-shaped member 46, it is possible to stabilize the support of the coil unit 10 with respect to the inside of the travel path R such as a road bed.

The above embodiment is described using an example in which the wall section 22a and the inner circumferential section 22b of the coil support portion 22 form a space in which the outer circumferential section of the lid portion 12 is arranged; however, the embodiment is not limited thereto. At least one of the wall section 22a and the inner circumferential section 22b may be in contact with the outer circumferential section of the lid portion 12 and support the lid portion 12.

In the embodiment described above, the front end (upper end) of the wall section 22a of the coil support portion 22 may form an identical surface to the road surface of the travel path R together with the upper surface 12B of the lid portion 12 or may be covered by the backfilling portion 43.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. A coil unit comprising:
a coil that transmits or receives electric power by contactless electric power transmission;
a coil support portion that supports the coil and has a penetration hole formed along a center axis line of the coil;
an accommodation portion that is arranged in the penetration hole of the coil support portion;
an electric device that is arranged inside the accommodation portion; and
a lid portion that closes and opens an open end of the penetration hole of the coil support portion and is supported by the accommodation portion when the penetration hole is closed.

2. The coil unit according to claim 1,
wherein the lid portion protrudes further than the coil toward a partner side in a case where an electric power transmission side and an electric power reception side of the electric power transmission face each other in an axis line direction parallel to the center axis line.

3. The coil unit according to claim 2, comprising:
an accommodation lid portion that closes and opens an opening formed in a region on a lid portion side of an outer circumferential section of the accommodation portion.

4. The coil unit according to claim 1, comprising:
a first yoke portion that is made of a magnetic material and is arranged on a rear side of the coil when seen from a lid portion side in an axis line direction parallel to the center axis line; and
a second yoke portion that is made of a magnetic material and is arranged so as to surround each of the lid portion side and a coil support portion side of a circumference of the accommodation portion in the penetration hole.

5. The coil unit according to claim 2, comprising:
a first yoke portion that is made of a magnetic material and is arranged on a rear side of the coil when seen from a lid portion side in an axis line direction parallel to the center axis line; and
a second yoke portion that is made of a magnetic material and is arranged so as to surround each of the lid portion side and a coil support portion side of a circumference of the accommodation portion in the penetration hole.

6. The coil unit according to claim 3, comprising:
a first yoke portion that is made of a magnetic material and is arranged on a rear side of the coil when seen from a lid portion side in an axis line direction parallel to the center axis line; and
a second yoke portion that is made of a magnetic material and is arranged so as to surround each of the lid portion side and a coil support portion side of a circumference of the accommodation portion in the penetration hole.

7. A coil unit installation structure comprising:
a coil unit according to claim 1 that is embedded in a travel path in a state where a surface of the lid portion is exposed to an outside; and
a base portion that supports the coil unit at an inside of the travel path.

8. The coil unit installation structure according to claim 7, comprising:
a support portion that is installed at the inside of the travel path,
wherein the base portion is fixed to the support portion by bonding or fastening.

9. The coil unit installation structure according to claim 7, comprising:
a plate-shaped member that is arranged between the base portion and the inside of the travel path.
